(19) United States
(12) Patent Application Publication
(10) Pub. No.: US 2017/0084231 A1
(43) Pub. Date: Mar. 23, 2017

(54) IMAGING SYSTEM MANAGEMENT FOR CAMERA MOUNTED BEHIND TRANSPARENT DISPLAY

(71) Applicant: INTEL CORPORATION, Santa Clara, CA (US)

(72) Inventor: YEN HSIANG CHEW, Georgetown (MY)

(73) Assignee: INTEL CORPORATION, Santa Clara, CA (US)

(21) Appl. No.: 14/863,306

(22) Filed: Sep. 23, 2015

(51) Int. Cl. G09G 3/34; G06F 3/041

(52) U.S. Cl. CPC G09G 3/3406; G06F 3/0416

(57) ABSTRACT

Imaging system management is described for a camera mounted behind a transparent display. In one example, the management includes determining whether an image sensor behind a transparent display is in an image capture mode, and if the image sensor is in an image capture mode then setting pixels of a sensor region of the display to a transparent mode during the image capture mode, the pixels of the sensor region comprising pixels of the display in a region around the image sensor. The management further includes determining whether the image sensor has finished the image capture mode, and if the image sensor has finished the image capture mode then setting the pixels of the display in the region around the image sensor to a display mode in which the pixels render a portion of an image on the display.

### FIELD

The present description relates to imaging systems with nearby displays and in particular to a system with an image sensor behind a display.

### BACKGROUND

Many devices are outfitted with cameras as a supplement to a display. Portable computers and desktop monitors may be augmented with a camera over the display to allow for videoconferencing. These cameras are now considered as suitable for user authentication, observing gesture commands and other uses. With game consoles a more complex camera array is mounted over the television to observe gestures and game play activity. Similarly smart phones and tablets also feature cameras above the display for video conferencing and for taking portraits of the user and friends.

With many uses, the view on the camera is presented on the display below the camera or on the display of a remote conferencing participant. Because the camera is above the display, when the user looks at the display, the user will appear to be looking down from the camera's perspective. There has been some effort to digitally manipulate the camera image to compensate for the camera's point of view. However, these digitally manipulated images do not have a full image of the user's and most rely on estimation or interpolation. With larger displays the effect of the camera being above the screen is increased. For digital signage or commercial displays, the effect is still greater.

The camera can be installed behind the display. This would allow the user to look directly into the camera while observing the display. However, for this to work, the camera must be able to see through the display. At the same time, the user wants a continuous image on the display without an obvious camera hole. For depth imaging as is used with some gaming console cameras, multiple camera holes might be required.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a diagram of a portable device with an image sensor behind a display according to an embodiment.

FIG. 2 is a diagram of a portable device with an image sensor behind a display according to an embodiment.

FIG. 3 is a diagram of a portable device with an image sensor behind a display using a sensor region and a guard region on the display according to an embodiment.

FIG. 4 is a diagram of a digital signage display with an image sensor behind a display according to an embodiment.

FIG. 5 is a process flow diagram of controlling a display that has an image sensor behind the display according to an embodiment.

FIG. 6 is a block diagram of a computing device incorporating interactive video presentation according to an embodiment.

### DETAILED DESCRIPTION

As described herein, one or more camera sensor may be mounted directly behind or on a transparent display, such as an OLED (Organic Light Emitting Diode) display to allow a camera to see through the display. To avoid interference between the light from the display and image capture by the camera, the image capture may be synchronized with the display. The display or a graphics engine may be configured so that only a small section of the display that is in front of the camera sensor will be transparent during image capturing. Other sections of the display will continue to present the normal graphical content with no change. This greatly reduces any user perception of flickering. As described herein, the device display is always in an active state with active graphical contents even during image capture.

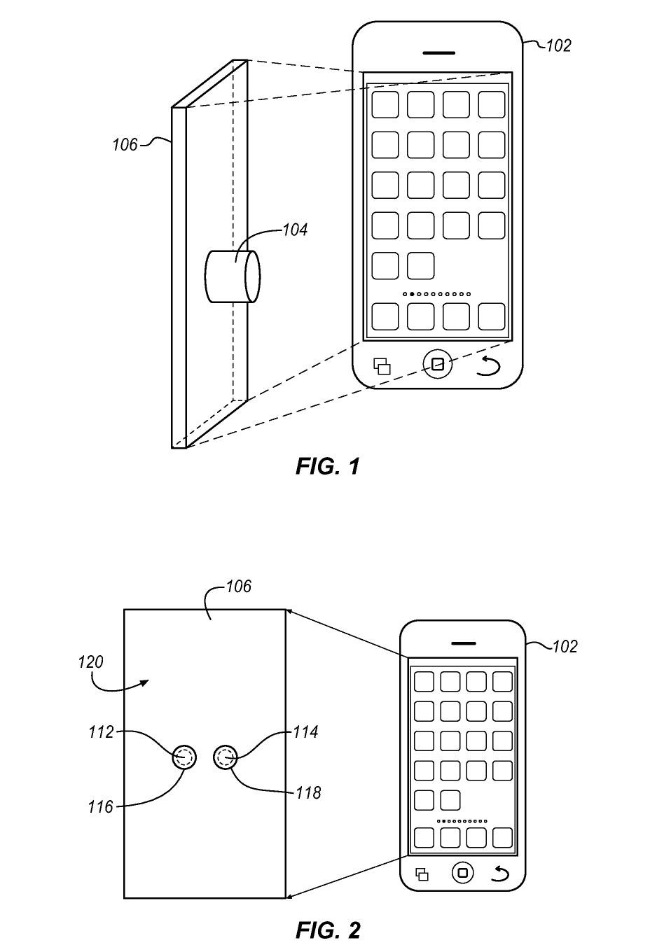

FIG. 1 is a diagram of a portable device 102 with a camera or image sensor 104 mounted on or behind a transparent display 106. While the camera is shown as being in the center of the display, the camera may be physically placed anywhere behind the display depending on the camera view that best suits the display. The display is shown also in a side view so that the image sensor is visible. The display may be an OLED display, an E-Ink or suitably adapted LCD (Liquid Crystal Display) display. During image capture, the system synchronizes the image sensor 104 with the display 106 and graphics engine (not shown) such that the display will be active all the time even during image capture.

In embodiments an OLED display may be used in which the OLED emitters are formed over a transparent substrate. The transparent substrate allows the camera to see through the substrate. The emitters or diodes of the OLED display as well as the conductive leads to drive the emitters may also be made of transparent materials. For a typical smart phone camera module, the emitters and wires are small compared to the camera lens, so that opaque emitters and wires may not interfere significantly with the images captured by the camera module, especially if the camera module is very close to the emitters and wires. Accordingly, it is not necessary that all of the components be transparent. Alternatively, the display may be transparent only over the locations that are within the field of view of the cameras. The rest of the substrate and conductors may be made from opaque materials for lower cost, higher display fidelity or both. E-ink and LCD displays may also be formed on transparent substrates and suitably modified to operate as described herein.

FIG. 2 is a diagram of the portable device 102 of FIG. 1 in which the display is shown as transparent to allow special features to be shown. Two small sections of the active display 116, 118 that are physically on top of the image sensor lenses 112,114 are identified as the sensor regions of the display. These may be configured or controlled to be transparent with no graphical content during image capture while other sections 120 of the display 106 continue to have active graphical contents. When there is no image capture, then the sections of the display over the image sensors act normally.

In this example two image sensors are shown. This allows there to be depth capture. Both of the two cameras are hidden behind the display. There may be more or fewer image sensors in any of a variety of different locations and arrangements to suit different uses. Some systems may have three cameras in which two cameras provide depth sensing for a third camera. The cameras may be the same or there may be different types of cameras to provide different functions such as narrow and wide angle, autofocus and fixed focus, visible and infrared light detection.

The placement of the camera behind the display allows the bezel of the device to be thinner. A smartphone, tablet, desktop display or other device may have a bigger touchscreen or display size because cameras are no longer accommodated within or above the display bezel. The screen may be larger despite having the same chassis form factor. An OLED display may be extended to cover the section of a device where the camera sensor is located.

In addition, the camera or cameras may be placed in a better location for smart devices as well as for digital signage. In signage implantations, camera sensors may be placed at the center of a signage screen for better viewer analytics using a frontal face view instead of the camera being placed on top of a signage media player with a 30 degree tilt angle facing down. When viewing a signage media player, a viewer will normally be looking straight at the signage display. As a result, an integrated image sensor will have a much better face acquisition position when it is physically placed behind a display where a viewer may be looking directly at the camera.

In the example device of FIGS. 1 and 2, normal operations are when the camera sensors are not used. The display and the graphics driver for the display functions like a normal display whether a touchscreen display or a conventional display. When the user wants to acquire an image, such as by taking a photograph or a video, the imaging system will switch to a different mode of operation.

The section 116, 118 of the display that is physically on top of the image sensor will be set to a transparent operation. This may be accomplished in a variety of different ways. In one example, the pixel values in the region that is physically on top of the image sensor are set to all black. For an OLED, a black area is one in which the light emitters are off. There is no color being generated so a transparent display will be transparent. As a result, any graphical contents on the region of the display that may potentially interfere with or block out the image sensor will be temporarily blotted out during image or video capturing.

After the image or video capture is finished, then the sensor regions 116, 118 of the display that are physically on top of the image sensors are restored to play the original graphical contents.

The modification of the image display may be done in a variety of different ways. In some embodiments, the graphical contents of the display may be modified by a function call to a graphics driver or to a display driver. A first transparent mode function or graphics call may cause the graphics or display driver to overlay a set of black pixel values, e.g. pixels with no color, over the sensor regions. The sensor region is the display region that is physically over or very close to the imaging sensor or camera. For an E-ink display, the call may cause white or blank pixels to be overlaid over the sensor regions. For an LCD (Liquid Crystal Display), the call may cause the liquid crystals of the sensor regions to be set to maximum brightness which corresponds to maximum transparency to the backlight. A second normal mode graphics call returns the display to normal operations, effectively cancelling the first graphics call.

In some multiple camera systems, not all of the cameras are used at all times. As an example, when there is a primary camera and one or more depth cameras, the depth camera may be used only when depth sensing in in operation. For videoconferencing or still photography, the depth cameras may be turned off. Similarly if the system includes infrared cameras, these may be used only when visible light levels are low or when the primary camera is to be augmented. With such a multiple camera array, when multiple image sensors are placed behind a display, the imaging system may selectively determine which of the multiple camera sensors are to be activated. One or more sensors may be used for any particular operational mode. The display driver, upon receiving this information may then selectively blot out or make transparent the sensor regions for the active cameras. The sensor regions for the other inactive cameras may then remain unaffected and continue to display the normal screen display.

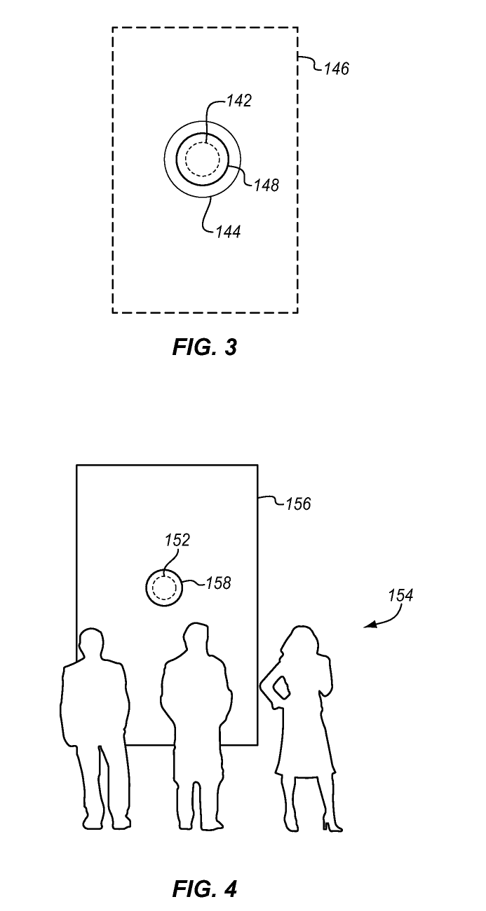

FIG. 3 is a diagram of a transparent display with an additional sensor guard region. A display 146 which may be transparent in any of the ways described herein has a camera or image sensor 142 behind the display. While only one camera is shown, there may be many more in any desired configuration or arrangement. As in the example of FIG. 2, there is also a sensor region 148 of the display surrounding the camera. The sensor region is switched to a transparent state when the camera is active.

In addition, there is a guard region 144 of the display 146 surrounding the sensor region 142. In some embodiments, this outer section of the display surrounding the sensor region is also set to a different guard state when the camera is in operation. This section does not need to be transparent because the sensor is not imaging through this region. Instead, the guard region is set to a guard state that has reduced brightness or contrast during camera operation. This further reduces the amount of stray light generated by the display that may enter the camera sensor. Illumination generated by the guard region could be reflected from surfaces near this region or be radiated laterally from this outer section and then interfere with a camera sensor during image acquisition.

The sensor region in this case includes all of the pixels of the display that are physically within the field of view of the camera lens. The pixels included in the sensor region will, accordingly, depend on the camera lens and its position. If the lens is very close to the display, then fewer pixels will be within the field of view than if the lens is farther away. The system changes the display behavior so that these pixels do not interfere with the camera when it is taking an image. The particular type of change depends on the display type. The display is adjusted so that these pixels are transparent and do not generate light that would interfere with the scene that the camera is trying to capture. A transparent OLED display has an array of emitters on a transparent substrate. The display is already transparent so the change is to turn off the emitters so that light from the emitters does not interfere with the camera image. Turning off the emitters is the same as setting those pixels to deep black.

The sensor region may also include pixels that are not directly within the field of view of the camera but are very close to the field of view of the camera. For an OLED the image is produced by emitters that generate very bright light in a small space. The light from a nearby emitter may also illuminate a portion within the field of view of the camera. The ability of the light to leak or bleed from one pixel into another will depend on the nature of the display. If there is such leakage, then these emitters may also be turned off. As a result, the sensor region may also include pixels near the pixels that are physically within the field of view of the camera. These additional pixels form a buffer to ensure that no emitter light is added to the camera images. The guard region includes another set of pixels that is outside the inner part of the sensor region and, if a buffer is used outside the buffer.

For an LCD, for example, the pixels do not emit light so there is no need for the buffer or the guard region. However, an LCD uses a backlight to illuminate the pixels. In addition to making the pixels of the sensor region transparent, the illumination from the backlight must be controlled so that it does not interfere with the camera image.

FIG. 4 is a diagram of a digital signage display. A display 156 is shown as having a large scale compared to observers 154 in front of the display. Such a display may be used as a media player for large areas or for vending, advertising or informational purposes. The display may be part of a kiosk, for example. In addition, such a large scale display may be used for video conferences or for games.

One or more cameras 152 are mounted behind the display and a display sensor region 158 is identified for each camera. The cameras may be mounted at eye-level for the viewers 154 so that it may observe the viewers directly at eye level. While a central camera may be best for a smart phone, notebook or desktop computer display, for a tall digital sign or display, the camera may be placed lower so that it is closer to eye level. This is particularly suitable for video conferencing and also for face recognition. As described herein, the sensor region is made transparent when the camera is in operation.

As described herein, the display 156 remains active when the camera or image sensor is acquiring an image or frames of a video. Only pixels in the sensor region 158 and the guard region 144, if used, are affected. The rest of the pixels are not. The section of the display that is physically on top of the camera sensor becomes transparent when the camera sensor is being used to acquire an image or a video frame. The rest of the display continues to have active graphical contents. By placing the camera behind the display, the camera is hidden from view. This provides more design freedom for producing a wide range of different devices. Future devices with user facing cameras may have larger screen sizes, thinner bezels and a cleaner, simpler looking housing with the cameras concealed. This may be more aesthetically appealing with some smartphone designs. The aesthetics are particularly improved for smartphone designs that use multiple user facing cameras.

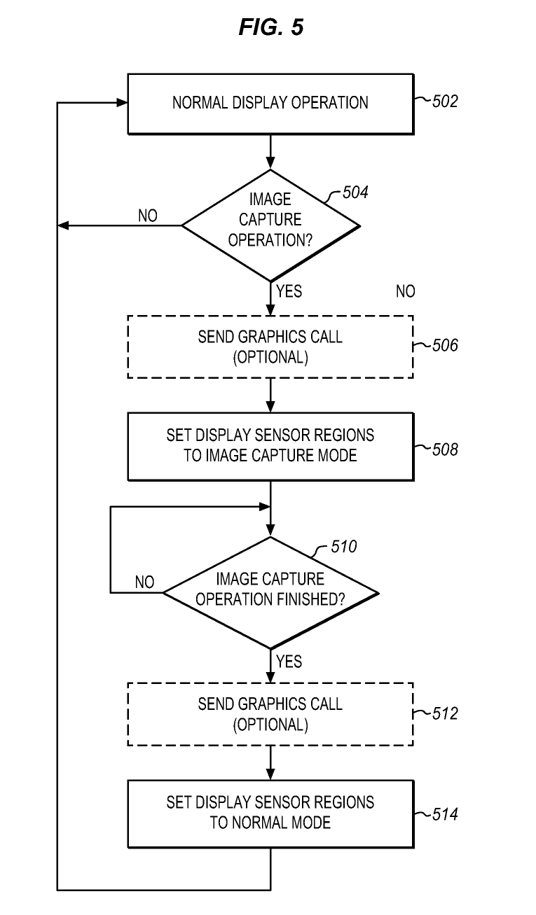

FIG. 5 is a process flow diagram of some of the operations described above. This process flow may be applied to a small hand held device or to larger devices from a tablet to a desktop display, to a conference room display to commercial signage. The process begins at 502 with normal display operation. In this mode or state, all of the pixels of the display are driven to provide the normal image. This is determined by a graphics driver or display driver. In some embodiments a graphics CPU receives instructions from a processor and drives each of the display pixels.

At 504, the processor, a camera driver, or an image processor associated with or incorporated into one or more cameras determines whether an image capture operation is to begin. If not, then normal display operation continues at 502. If an image capture is to begin, then a special image capture mode is started at 506. In some embodiments, the image capture is started by the processor which at 506 optionally sends a first transparent mode graphics call to the graphics driver or to the graphics CPU, depending on the implementation. The graphics driver may then cause operations to be performed at the graphics CPU or the processor, depending on the hardware and graphics configuration of the system.

At 508 the display sensor regions are set to an image capture mode. This is a mode that allows the relevant cameras to capture an image through the display. As mentioned above, for a transparent OLED display, the pixels in the sensor regions are set to off which corresponds to black. In some embodiments, the pixels in the guard region are also set to a lower luminance or darker level. For other types of displays, the pixels may be affected differently.

For a multiple camera array, the graphics call may indicate which cameras are going to be in a capture mode so that only the sensor regions for active cameras are affected. The sensor regions for inactive cameras remain in normal mode.

At 510 it is determined whether the camera image capture operation is finished. If not, then the sensor regions and optional guard regions remain in image capture mode at 508. If so then, a second normal mode graphics call is optionally sent to the appropriate driver or processor at 512. Upon receiving this call, the display returns to normal mode at 514. The display sensor regions and guard regions are set to and operated in normal mode. The process returns to normal mode at 502.

In some embodiments, when image capture involves capturing a series of consecutive images, such as a video, sensor regions and guard regions may repeatedly switch between capture mode and normal mode during each consecutive image acquisition operation. In other words, the sensor region returns to normal mode between each frame of the video. The determination of whether an image capture begins 504 and ends 510 is performed before and after each image or frame of the video sequence of frames. Many display types are able to switch on and off at a rate much more quickly than the 24, 30 or even 60 frames per second rate used for video. However, this fast switching may cause the flickering of the display to be noticeable to the viewer of the display.

In other embodiments, sensor regions and/or guard regions may remain in capture mode as long as there are additional images to be captured by the image sensor. In this embodiment, the image capture operation is done only after the image sensor acquires the last image of the video. After the last image, the sensor regions and guard regions return to normal mode. This may reduce or prevent flickering on the sensor regions and guard regions.

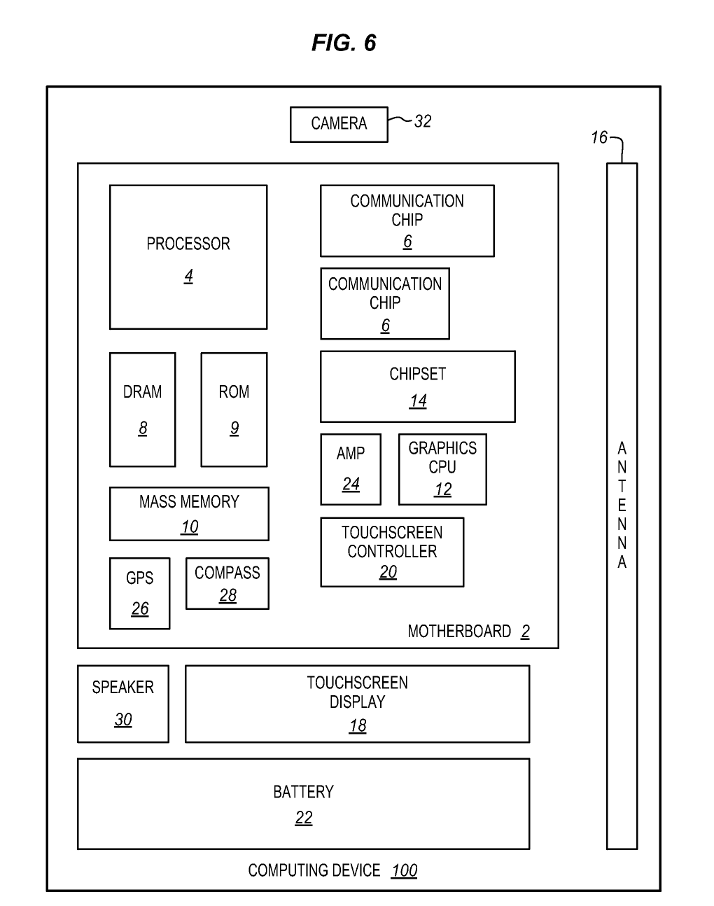

FIG. 6 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 contain image sensors with pixels or photodetectors as described herein. The image sensors may use the resources of an image processing chip 3 to read values and also to perform format conversion, coding and decoding, noise reduction and 3D mapping, etc. The processor 4 is coupled to the image processing chip to drive the processes, set parameters, etc.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, an embedded computing device, such as a kiosk or digital sign, a server, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes determining whether an image sensor behind a transparent display is in an image capture mode, and if the image sensor is in an image capture mode then setting pixels of a sensor region of the display to a transparent mode during the image capture mode, the pixels of the sensor region comprising pixels of the display in a region around the image sensor. The management further includes determining whether the image sensor has finished the image capture mode, and if the image sensor has finished the image capture mode then setting the pixels of the display in the region around the image sensor to a display mode in which the pixels render a portion of an image on the display.

In further embodiments the sensor region corresponds to a region directly within the field of view of the image sensor.

In further embodiments the sensor region further includes a buffer of pixels that are very close to but not directly within the field of view of the image sensor.

Further embodiments include setting pixels of a guard region to a guard state if the image sensor is in an image capture mode, the guard state having reduced brightness compared to the display mode.

In further embodiments the guard region comprises pixels surrounding the pixels of the sensor region.

In further embodiments the transparent mode comprises an off mode for emitters corresponding to the pixels in the sensor region.

In further embodiments the transparent mode comprises a transparent setting for liquid crystals corresponding to pixels in the sensor region.

In further embodiments the transparent mode comprises a transparent setting for E-ink corresponding to pixels in the sensor region.

Further embodiments include sending a transparent mode graphics call to a graphics driver in response to determining whether the image sensor is in an image capture mode and wherein setting pixels to a transparent mode comprises setting the pixels in response to the graphics call.

Further embodiments include a second image sensor and a second sensor region, wherein the transparent mode graphics call indicates that only the first image sensor is in an image capture mode, and wherein setting the pixels of the sensor region to transparent mode comprises setting only the pixels of the first sensor region to the transparent mode.

In further embodiments determining whether the image sensor has finished comprises determining whether the image sensor has finished capturing one image in a sequence of images for a video capture and wherein determining whether the image sensor is in an image capture mode comprises determining whether the image sensor is capturing a next image in the sequence of images.

Some embodiments pertain to an apparatus that includes a transparent display having pixels to display an image, an image sensor behind the transparent display, a sensor region of the display having pixels of the display in a region around the image sensor, the pixels of the sensor region having a normal mode to display a portion of the image and a transparent mode, and a processor to determine whether the image sensor is in an image capture mode and to determine whether the image sensor has finished the capture mode, wherein if the image sensor is in the image capture mode then the pixels of the sensor region are set to the transparent mode, and wherein if the image sensor has finished the image capture mode then the pixels of the sensor region are set to the normal mode.

In further embodiments the sensor region corresponds to a region directly within the field of view of the image sensor.

In further embodiments the sensor region further includes a guard region that includes a buffer of pixels that are very close to but not directly within the field of view of the image sensor.

In further embodiments pixels of the guard region are set to a guard state if the image sensor is in the image capture mode, the guard state having reduced brightness compared to the display mode.

Further embodiments include a graphics processor running a graphics driver to control the pixels of the display and wherein the processor further sends a first graphics call to the graphics driver in response to determining that the image sensor is in an image capture mode and wherein the graphics processor sets the sensor region pixels to the transparent mode in response to the graphics call.

In further embodiments the processor further sends a second graphics call to the graphics driver in response to determining that the image sensor has finished the image capture mode and wherein the graphics processor sets the sensor region pixels to the display mode in response to the graphics call.

Some embodiments pertain to a computing device that includes a transparent display having pixels to display an image, a touchscreen controller coupled to the transparent display to receive user input, an image sensor behind the transparent display, the image sensor including a lens with a field of view; a sensor region of the display having pixels of the display in a region within the field of view of the image sensor lens, the pixels of the sensor region having a normal mode to display a portion of the image and a transparent mode, and a processor coupled to the touchscreen controller to receive the user input and to determine whether the image sensor is in an image capture mode and to determine whether the image sensor has finished the capture mode, wherein if the image sensor is in the image capture mode then the pixels of the sensor region are set to the transparent mode, and wherein if the image sensor has finished the image capture mode then the pixels of the sensor region are set to the display mode.

Further embodiments include a graphics processor running a graphics driver to control the pixels of the display and wherein the processor further sends a first graphics call to the graphics driver in response to determining that the image sensor is in an image capture mode, wherein the graphics processor sets the sensor region pixels to the transparent mode in response to the first graphics call, wherein the processor further sends a second graphics call to the graphics driver in response to determining that the image sensor has finished the image capture mode and wherein the graphics processor sets the sensor region pixels to the display mode in response to the second graphics call.

In further embodiments the display is an organic light emitting diode display having an emitter for each pixel and wherein the transparent mode comprises an off mode for emitters corresponding to the pixels in the sensor region

What is claimed is:

1. A method comprising;
determining whether an image sensor behind a transparent display is in an image capture mode;
if the image sensor is in an image capture mode then setting pixels of a sensor region of the display to a transparent mode during the image capture mode, the pixels of the sensor region comprising pixels of the display in a region around the image sensor;
determining whether the image sensor has finished the image capture mode; and
if the image sensor has finished the image capture mode then setting the pixels of the display in the region around the image sensor to a display mode in which the pixels render a portion of an image on the display.

2. The method of claim 1, wherein the sensor region corresponds to a region directly within the field of view of the image sensor.

3. The method of claim 2, wherein the sensor region further includes a buffer of pixels that are very close to but not directly within the field of view of the image sensor.

4. The method of claim 2, further comprising setting pixels of a guard region to a guard state if the image sensor is in an image capture mode, the guard state having reduced brightness compared to the display mode.

5. The method of claim 4, wherein the guard region comprises pixels surrounding the pixels of the sensor region.

6. The method of claim 1, wherein the transparent mode comprises an off mode for emitters corresponding to the pixels in the sensor region.

7. The method of claim 1, wherein the transparent mode comprises a transparent setting for liquid crystals corresponding to pixels in the sensor region.

8. The method of claim 1, wherein the transparent mode comprises a transparent setting for E-ink corresponding to pixels in the sensor region.

9. The method of claim 1, further comprising sending a transparent mode graphics call to a graphics driver in response to determining whether the image sensor is in an image capture mode and wherein setting pixels to a transparent mode comprises setting the pixels in response to the graphics call.

10. The method of claim 9, further comprising a second image sensor and a second sensor region, wherein the transparent mode graphics call indicates that only the first image sensor is in an image capture mode, and wherein setting the pixels of the sensor region to transparent mode comprises setting only the pixels of the first sensor region to the transparent mode.

11. The method of claim 1, wherein determining whether the image sensor has finished comprises determining whether the image sensor has finished capturing one image in a sequence of images for a video capture and wherein determining whether the image sensor is in an image capture mode comprises determining whether the image sensor is capturing a next image in the sequence of images.

12. An apparatus comprising:
a transparent display having pixels to display an image;
an image sensor behind the transparent display;
a sensor region of the display having pixels of the display in a region around the image sensor, the pixels of the sensor region having a normal mode to display a portion of the image and a transparent mode; and
a processor to determine whether the image sensor is in an image capture mode and to determine whether the image sensor has finished the capture mode, wherein if the image sensor is in the image capture mode then the pixels of the sensor region are set to the transparent mode, and wherein if the image sensor has finished the image capture mode then the pixels of the sensor region are set to the normal mode.

13. The apparatus of claim 12, wherein the sensor region corresponds to a region directly within the field of view of the image sensor.

14. The apparatus of claim 13, wherein the sensor region further includes a guard region that includes a buffer of pixels that are very close to but not directly within the field of view of the image sensor.

15. The apparatus of claim 13, wherein pixels of the guard region are set to a guard state if the image sensor is in the image capture mode, the guard state having reduced brightness compared to the display mode.

16. The apparatus of claim 12, further comprising a graphics processor running a graphics driver to control the pixels of the display and wherein the processor further sends a first graphics call to the graphics driver in response to determining that the image sensor is in an image capture mode and wherein the graphics processor sets the sensor region pixels to the transparent mode in response to the graphics call.

17. The apparatus of claim 16, wherein the processor further sends a second graphics call to the graphics driver in response to determining that the image sensor has finished the image capture mode and wherein the graphics processor sets the sensor region pixels to the display mode in response to the graphics call.

18. A computing device comprising:
a transparent display having pixels to display an image;
a touchscreen controller coupled to the transparent display to receive user input;
an image sensor behind the transparent display, the image sensor including a lens with a field of view;
a sensor region of the display having pixels of the display in a region within the field of view of the image sensor lens, the pixels of the sensor region having a normal mode to display a portion of the image and a transparent mode; and
a processor coupled to the touchscreen controller to receive the user input and to determine whether the image sensor is in an image capture mode and to determine whether the image sensor has finished the capture mode, wherein if the image sensor is in the image capture mode then the pixels of the sensor region are set to the transparent mode, and wherein if the image sensor has finished the image capture mode then the pixels of the sensor region are set to the display mode.

19. The computing device of claim 18, further comprising a graphics processor running a graphics driver to control the pixels of the display and wherein the processor further sends a first graphics call to the graphics driver in response to determining that the image sensor is in an image capture mode, wherein the graphics processor sets the sensor region pixels to the transparent mode in response to the first graphics call, wherein the processor further sends a second graphics call to the graphics driver in response to determining that the image sensor has finished the image capture mode and wherein the graphics processor sets the sensor region pixels to the display mode in response to the second graphics call.

20. The computing device of claim 18, wherein the display is an organic light emitting diode display having an emitter for each pixel and wherein the transparent mode comprises an off mode for emitters corresponding to the pixels in the sensor region.
